(19) United States
(12) Patent Application Publication
(10) Pub. No.: US 2017/0161853 A1
(43) Pub. Date: Jun. 8, 2017

(54) MAPPING SYSTEM THAT IDENTIFIES SITE-SPECIFIC REAL ESTATE DUE DILIGENCE PROFESSIONALS AND RELATED SERVICE PROVIDERS

(71) Applicants: James Carroll Gossweiler, Pikesville, MD (US); Joseph Edgar Manduke, III, Peoria, AZ (US)

(72) Inventors: James Carroll Gossweiler, Pikesville, MD (US); Joseph Edgar Manduke, III, Peoria, AZ (US)

(21) Appl. No.: 15/369,284

(22) Filed: Dec. 5, 2016

Related U.S. Application Data
(60) Provisional application No. 62/262,486, filed on Dec. 3, 2015.

(51) Int. Cl. G06Q 50/16; G06F 17/21; G06F 17/30

(52) U.S. Cl. CPC G06Q 50/16; G06F 17/30864; G06F 17/218; G06F 3/0482

(57) ABSTRACT

There is provided an applied mapping program system that identities site-specific real estate due diligence professionals, engineering, and architectural consultants, contractors, and related service providers based on their services, and those they have performed at a given physical address, and methods for'same. The system identifies site-specific real estate due diligence reports based on a given physical location regardless of a provided physical address.

### CROSS-REFERENCE TO RELATED APPLICATION(S)

The present application derives priority from U.S. Provisional Patent Application Ser. No. 62/262,486, filed 3 Dec. 2015.

### BACKGROUND OF THE INVENTION

The present invention relates to an applied mapping program that through use of coded icons identifies specific real estate due diligence professionals and related engineering service providers based on their services and the services they have performed already on specific addresses and geographical locations.

Commercial real estate lenders, buyers, sellers, brokers, appraisers, collateral risk managers, and other real estate professionals directly or indirectly involved in real estate due diligence and assessment do not have access to a readily available system or method to identify and directly contact due diligence, engineering, and architectural consultants and other real estate professionals that may have already inspected, assessed, or otherwise have performed some service (including physical repairs) on a given real property. As such, many due diligence inspection and related services contracted for are unnecessarily costly, redundant, and time-inefficient. Existing systems, e.g. lists, directories, and the like constructs do not establish any kind of correlation between real estate due diligence consultants, related professionals, and physical service providers (contractors) and specific addresses or geographical locations.

Moreover, due to the above limitations in the current system and for legal reasons when ownership of real property is transferred, it is oleo the case that many successive such reports will be produced on a given piece of real property without the benefit of having the report's preparer (or the property owner or other interested party) review prior reports on the same physical address.

Other practical limitations also reduce or confound the ability of due diligence professionals to assess the full scope of prior reports on a given physical location prior to preparing a new assessment, and of real estate professionals to assess the full history of reports that have actually been prepared with respect to a given physical location, For example, in some cases one or more structures on a given property may be demolished after the generation of a site assessment report on that property. In other cases, infrastructure may be constructed, or a property may be subdivided resulting in new or different postal addresses on what was once a single parcel and/or one or more parcels with different postal addresses. All of these circumstances make it difficult for someone who wishes to see the full complement of site assessment reports that have been prepared with respect to a given physical location (versus an address). This is in addition to the problem identified above, which is that even where physical structures on a property and property subdivision remain consistent, the existence of past reports may not be readily discernable, not to mention the identity of the person or firm that prepared it and/or the location or contents of the report.

As can be seen, there is a need for an applied mapping program that identifies site-specific real estate due diligence professionals, engineering, and architectural consultants, contractors, and related service providers based on their services and those they have performed at a given physical address.

Moreover, there is a need for an applied mapping program that identifies site-specific real estate due diligence reports based on a given physical location regardless of a provided physical address.

### BRIEF DESCRIPTION OF THE DRAWINGS

FIG. 1 is a schematic of the system architecture of the system according to the present invention

FIG. 2 is an illustrative graphical user interface (GUI) generated by system 100 according to the present invention.

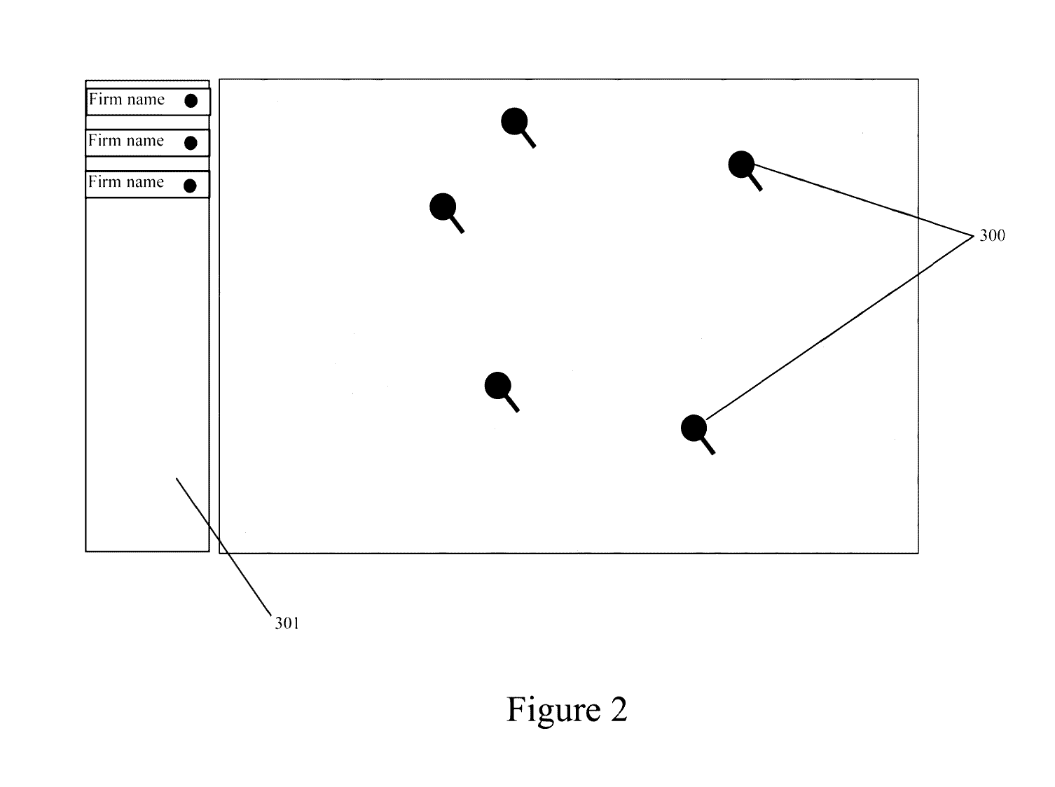

### SUMMARY OF THE INVENTION

The present invention includes an applied mapping program that identifies specific real estate due diligence professionals and related service providers based on either a postal or “street” address and/or on a map view by physical location. The applied mapping program allows users to immediately identify due diligence consultants and other real estate professionals (including repair contractors) that may have already inspected, assessed, or otherwise have performed some physical service on a given property or geographical location, to contact those professionals, and to view reports generated by same, using a property address or physical location as the only reference point.

The foregoing objects, features and attendant benefits of this invention will, in part, be pointed out with particularity and will become more readily appreciated as the same become better understood by reference to the following detailed description of a preferred embodiment and certain modifications thereof when taken in conjunction with the accompanying drawings.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

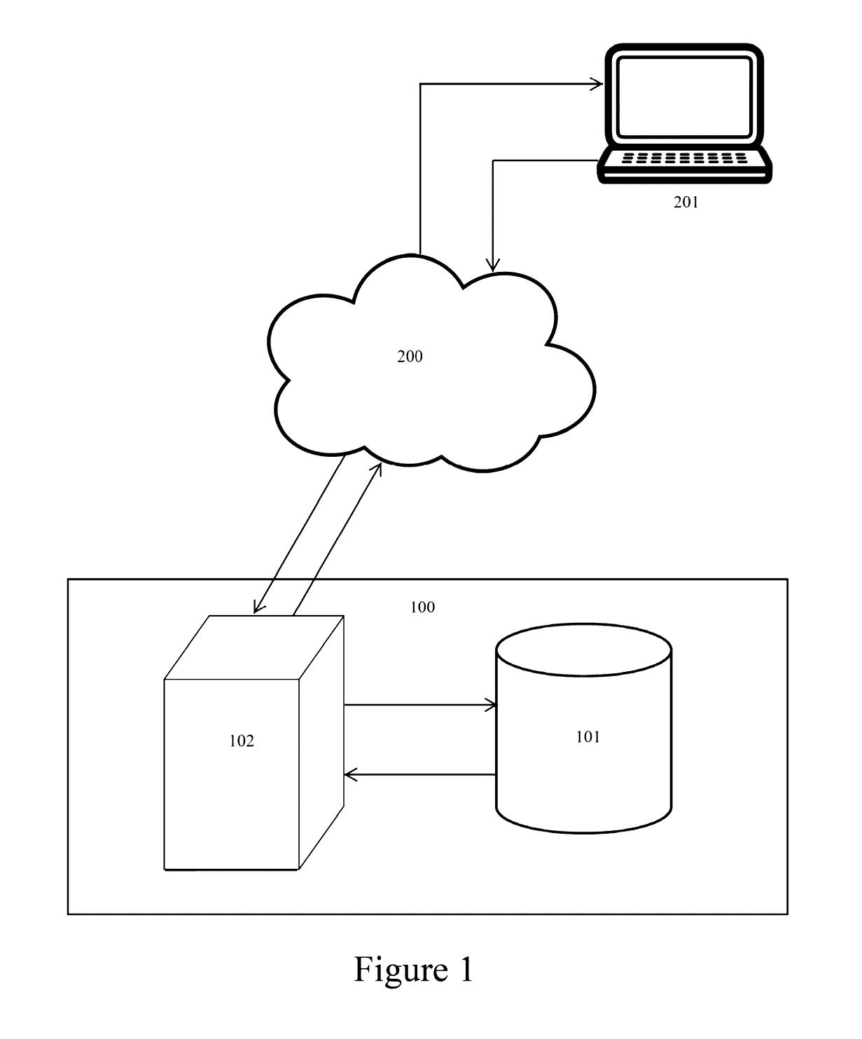

FIG. 1 illustrates the system architecture of the present system. The report mapping system 100 consists of at least one application sever 102 and at least one secure database management system 101 accessible by the application servers) 102. In certain embodiments of the disclosed invention, system 100 may also employ a web server (not shown) to facilitate communication between client workstations 201 (as described below) and application server 102 for facilitating the processes performed by the system according to the instant disclosure.

An Internet browser running on a client-side workstation 201 such as a laptop, PDA or desktop equipped with an input device such as a mouse, keyboard, stylus, or voice to text conversion, is required for user access to the report mapping system. The system 100 is connected to any number of workstations 201 via a communications network 200 such as the Internet. Of course, it will be understood that any number of communications networks, such as closed intranet systems, could be used as network 200 herein.

In certain embodiments of the present invention, a firewall (not shown) between system 100 and network 200 may be used to add additional security to system 100. It is envisioned that users at remote workstations 201 will initially create an account, including sign-in credentials such as a username and password, among other identifying information, provided during a sign-up process which is assisted by the application server 102 through the generation of a graphical user interface (GUI) soliciting this information and any other information that the system's administrator may wish to require. Information collected during the sign-up process will be forwarded by the application server 102 to database 101 for storage in connection with each unique username or other unique identifying information of the user.

To access the system 100 after sign-up, the user transmits, via his or her remote workstation 201, a request to application server 102 (or firewall and/or web server when present) which in turn authenticates the user's sign-in credentials based on asymmetric cryptography or other known means. Thereafter, under normal operation of the system, the user forwards one or more requests to system 100, which are acted upon by, firewall, web server ardor application server, and application server performs the requested actions, such as searching, storing, retrieving, etc. data objects that are stored and retrieved using database management system 101.

In certain embodiments, actual storage media can be bandied externally by a storage area network (not shown). Also in some embodiments, all network and application traffic can be mirrored to an external application security module (not shown) for intrusion detection and prevention monitoring and alerting. The system 100 according to the present invention provides centralized support for a distributed network of clients at various types of remote workstations 201.

In addition to user-specific data, database 101 houses a large catalog of datasets, reports, including site assessment reports, observations and other documents generated by real estate due diligence consultants, related professionals, and physical service providers (contractors) (collectively, “assessments”). Assessments housed in database 101 are tagged with pre-determined coding information upon collection from the providers of the assessments, wherein codes could be used to represent any type of identifying information for such assessments that a user (or system administrator) may wish to associate with a given assessment for sorting, filtering, and/or searching operations or for database organization. In a preferred embodiment, each assessment is tagged with at least three types of information: (1) postal address information (2) physical location information; and (3) preparer information. Preparer information preferably includes: (1) the name of the firm that prepared the assessment, if any; (2) the name of the individual professional that prepared the assessment, if known; (3) the address and other contact information for the firm and/or professional that prepared. the assessment; (4) the date(s) on which the assessment(s) were prepared; and (5) a logo associated with the firm and/or professional that prepared the assessment. In some embodiments of the present invention, database 101 utilizes an indexing function to house assessments and the specific information tagged to each such assessment.

The hardware and software components of system 100's architecture enable the operation of the site assessment map searching program according to the present disclosure. The system's functionality allows a user, working at a remote workstation 201 with at least one input device, to access a GUI 302 featuring a map of a desired location populated with icons indicating the street address(es) and/or physical location(s) within the viewing range on which one or more due diligence consultants, related professionals, and/or physical service providers has previously inspected or else worked on (i.e., to generate one or more datasets, reports, including site assessment reports, observations and other documents collectively referred to herein as “assessments”). With respect to each of these properties and/or physical locations, the user Fill also be able to ascertain the number of previous assessments done on a given physical location, and the identity of the firm and/or individual professional that completed each assessment, via the system-generated GUI 302. In a preferred embodiment, the user may also be able to view the date(s) of previous assessment(s), also via the system-generated GUI 302. The user will also he able to view and/or request copies of each assessment housed in the system's database 101. In certain embodiments, the user will also be able to request copies of assessments not specifically housed in the system's database 101 if the database 101 includes information tagged to the specific physical address/location that an assessment was completed and the substantive content of same may be located through means other than by querying the database 101. In yet other embodiments of the present invention, the system may be programmed to allow a user to select a given street address and/or physical location, which in turn will cause the system to generate a query, displayed as a notice on a public-facing website managed via application server 102 or a third party; and/or an email message sent to a predetermined or system-selected email listserv of service providers, requesting any information regarding an assessment done at the given street address and/or physical location where none is housed in database 101 at the time of the user query.

With reference to FIG. 1, in addition to the features described above, the GUI 302 generated by the system may display the generated results on a map view by importing map data from a third party vendor and overlaying assessment data from database 101 onto the map. For each street address or physical location on which the database 101 houses assessment data, as determined by a search of the database 101 by application server 102 via the tagged criteria described above, the system 100 generates an icon 300 which is then overlayed based on matching longitude/latitude data onto the map GUI 302 at the street address/physical location that the assessment data pertains to. This process provides a physical illustration to the user of physical locations on which known assessment data has been collected. In preferred embodiments of the present invention, icon 300 may also display as provider logo information which is housed in the database 101 in connection with the assessment data as described above. In addition to or in the alternative to this feature, logo and/or provider identification data may display in a sidebar 301 of GUI 302 with color coordination, numbering, or the like associating each icon 300 with the appropriate provider. Alternatively, logos could be used to associate each provider with icons 300 displayed on GUI 302, but not necessarily the trademark/professional logo of the given provider(s). In a preferred embodiment, the sidebar 301 is populated with the logos of those companies or individual contractors who have the greatest number of assessments, housed in the database 101, for properties in the viewing range of the map generated by system 100. The company and/or individual logo may be used in places other than the sidebar 301, such as on the map itself in geographical, proximity to the property or street address with respect to which the assessment was generated.

Other optional features of the herein-described system include a request or direct-request function(s) by which the user may query the system 100 for contact information for either the system administrator or the assessment provider to allow the user to contact this entity directly for additional information about the assessment or to review the full content of same. This may be accomplished through an online fillable form which would then generate an email to that party without the system 100 disclosing the party's email address to the user. Alternatively, the system 100 could be programmed to allow the user to view the content of any assessment housed in database 101 directly in the GUI by generating a dynamic “request” button which would in turn generate a query to the database 101 for any electronic copies of a selected assessment that could be displayed to a user.

Thus, in use, application server 102 receives a login request from a user via a remote workstation, 201, to access system 100. Application server 102 and/or web server and/or firewall (not shown) provide verification of the user's login credentials using known means, or direct the user to a sign-up tillable form as described above.

Application server 102 then receives a search request from the authenticated user via a remote workstation 201 and network 200. Search request may contain location information comprising a street address. Upon receipt of the search request, application server 102 queries database 101 or an optional third party mapping application to determine a latitude and longitude associated with the street address contained in the search request. Application server 102 then accesses a map generation application to generate a geographic map of the latitude and longitude associated with the search request and the immediately surrounding area, and displays this via a GUI viewable by the user at his remote workstation 201.

Application server 102 then queries database 101 with the latitude/longitude information associated with the street address, as well as the associated street address, and all coordinate and street address data within the mapped area contained in the present GUI. The database 101 returns with data on any assessments that match any of the queried criteria, as well as any logo, numeric, or color tags (as described above) associated with the assessment's associated provider. Application server 102 extracts logo, numeric and/or color tags from the data returned by the database 101 along with their associated coordinate data, and matches coordinate data to coordinates on the generated map to populate the map with a series of icons, each located at the coordinates of each known assessment data visible within the GUI's map area, each icon providing the pre-determined information about the respective assessment's provider for ease of reference by the user. In some embodiments, application server 102 also creates sidebar 301 displaying additional, predetermined information about the provider(s) of assessments made on locations visible in the GUI map area.

In preferred embodiments, the user may alter the map area displayed on the system-generated GUI by zooming in or out, or panning in multiple directions. Each time this is done, the system 100 will send additional queries to database 101 for all information correlated with coordinates in the new viewing area.

As described above, each system-generated icon 300 includes a link to additional information about the associated geographical location. Linked information may include the number and, optionally, dates of any assessment data collected on that specific geographic location, identity and/or contact information of the provider(s) collecting that information, or actual assessment report data and/or images. Icons 300 may also link to online tillable forms that allow a user to send an email and/or other electronic information request to either the assessment provider(s) or the system administrator requesting additional information or relaying other specific questions or comments about a specific geographic location and/or any assessment data available there.

It is anticipated that one or more separate provider may have provided information to the system 100 (as described below) for a given geographic location. In that case, a user's selection of a specific logo or geographic location may generate a list of multiple providers, such as in sidebar 301.

In addition, as described above, in certain embodiments the system may allow the user to generate a query by selecting an area of the GUI that does not contain an icon 300, whereby the system could generate a request as described above containing the coordinates of such location of a looked-up address(es) correlated to same.

Additional functionality may be added to the system 100 via an assessment upload function. That is, application server 102 may generate an upload GUI (not shown) in which a provider of certain assessment data or reports would be invited to input certain information relating to one or more assessments that provider has generated. Input data preferably includes: (1) identifying and contact information for the provider; (2) identifying information for the individual professional that prepared the. assessment; (3) assessment data; (4) provider logo information; and (5) other information as the system administrator may require or request

Once the requested information and/or documents are transmitted to system 100 via network 200 by users from workstations 201, application server 102 will apply the above-described codes to each bit of information for purposes of indexing and housing same in database 101.

The computer-based data processing system and method described above is for purposes of example only, and may be implemented in any type of computer system or programming or processing environment including a smart phone device application, or in a computer program, alone or in conjunction with the hardware described herein. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the resent invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

Having now fully set forth the preferred embodiment and certain modifications of the concept underlying the present invention, various other embodiments as well as certain variations and modifications of the embodiments herein shown and described will obviously to those skilled in the art upon becoming familiar with said underlying concept. It is to, be understood, therefore, that the invention may be practiced otherwise than as specifically set forth in the appended claims.

What is claimed is:

1. In a data processing system that includes at least one remote computer workstation, that is connected via a communications network to at least one site assessment report mapping system consisting of at least one application server and at least one secure database management system, a method of identifying site-specific real estate due diligence professionals and related service providers comprising the steps of:
receiving, by said at least one application server, at least one search request from one of said at least one remote workstations;
generating, by said at least one application server, a query for latitude and longitude information associated with said search request;
receiving, by said application sewer, said latitude and longitude information;
generating, by said application server, a graphical user interface comprising a map containing a visual representation of known elements present at a location associated with said latitude and longitude data and an immediately surrounding area;
querying, by said application server, said database for assessment information related to said latitude and longitude information;
receiving, by said application server from said database, said assessment information; and
displaying, by said application server, one or more logos associated with said assessment information on said graphical user interface;
wherein said one or more logos are generated using tagged information associated with said assessment information.

2. The method of claim 1, wherein said at least one search request includes postal address data.

3. The method of claim 1, wherein said at least one search request includes assessment, provider data.

4. The method of claim 1, wherein said step of generating, by said application server, a graphical user interface further comprises:
querying, by said application server via said communications network, a third party mapping application; and
receiving, by said application server, data sufficient to enable the generation of the graphical user interface by said application server.

5. The method of claim wherein said step of generating, by said application serer, a graphical user interface further comprises displaying map data generated by a third party system,

6. The method of claim 1, wherein said step of displaying, by said application server, one or more logos associated with said assessment information on said graphical user interface further comprises:
extracting, from said assessment information, at least one of logo, numeric and/or color tags from said assessment data and coordinate data associated with same; and
matching said coordinate data to coordinates on said graphical user interface,

7. The method of claim 6 further comprising linking said one or more logos with said associated assessment data.

8. The method of claim 1, further comprising generating, by said application server, a sidebar on said graphical user interface populated with said assessment data.

9. In a data processing system that includes at least one remote computer workstation, that is connected via a communications network to at least one site assessment report mapping system consisting of at least one application server and at least one secure database management system, a method of collecting information on site-specific real estate due diligence professionals and related service providers comprising the steps of:
generating, by said application server, a graphical user interface to collect one or more items selected from the group consisting of identifying and contact information for a provider, identifying information for an individual professional that prepared an assessment, assessment data, or logo information;
receiving, by said application server, assessment data related to one or more physical locations;
storing, by said application server, said assessment data in said database;
indexing, by said application server, said assessment. data with at least one of said identifying and contact information for said provider, identifying information for said individual professional that prepared said assessment, assessment data, or logo information.
